(19) United States
(12) Patent Application Publication
(10) Pub. No.: US 2003/0115136 A1
(43) Pub. Date: Jun. 19, 2003

(54) Method for pre-paid transaction system

(76) Inventor: Magnus Sjolin, Grillby (SE)

Correspondence Address: Rolf Fasth, FASTH LAW OFFICES, 629 E Boca Raton, Phoenix, AZ, 85022, US

(21) Appl. No.: 10/321,126

(22) Filed: Dec. 16, 2002

Related U.S. Application Data
(60) Provisional application No. 60/341,487, filed on Dec. 17, 2001.

(51) Int. Cl. G06F 17/60

(52) U.S. Cl. 705/39; 705/40

(57) ABSTRACT

The method is for transacting business on the Internet. The system 10 has a consumer 12 connected to a financial unit 14 and an Internet content provider 16 and a payment service provider 18. The consumer 12 provides the financial unit 14 with a pre-paid fund 20. The consumer 12 sends a purchase signal 19 to purchase a product/service 32 from the Internet content provider 16. The Internet content provider 16 receives the purchase signal 19 and sends a withdrawal signal 24a to the payment service provider 18 that withdraws a portion 34 of the fund 20 from the financial unit 14 and sends the portion 34 in a payment signal 25 to the Internet content provider 16. The Internet content provider 16 provides the product/service 32 to the consumer 12.

### PRIOR APPLICATION

This application claims priority from U.S. Provisional Application No. 60/341,487; filed Dec. 17, 2001.

### TECHNICAL FIELD

The present invention relates to a method for a pre-paid transaction system such as a pre-paid cash system for Internet purchasing.

### BACKGROUND AND SUMMARY OF INVENTION

The Internet has become a very important source for buying services and products. A common way of paying for the goods and services is by using a credit card. This payment method excludes all potential customers that do not have a credit card. Other payment methods such as checks or cash are very cumbersome and may expose the seller to an undue credit risk. For example, the seller may not want to receive a check is there are insufficient funds to support the check. The payment with cash excludes any customer that is far away from the seller. There is a need for a payment method that would enable customers without a credit card to conveniently pay for goods and services on the Internet without exposing the seller for undue risk.

The payment method of the present invention provides a solution to the above-outlined problems. More particularly, the method is for transacting business on the Internet. The system has a consumer connected to a financial unit, an Internet content provider and a payment service provider. The consumer provides the financial unit with a pre-paid fund. The consumer sends a purchase signal to purchase a product/service from the Internet content provider. The Internet content provider receives the purchase signal and sends a withdrawal signal to the payment service provider that withdraws a portion of the fund from the financial unit and sends the portion in a payment signal to the Internet content provider. The Internet content provider provides the product/service to the consumer.

### BRIEF DESCRIPTION OF DRAWINGS

FIG. 1 is a schematic illustration of components of the pre-paid transaction system of the present invention.

### DETAILED DESCRIPTION

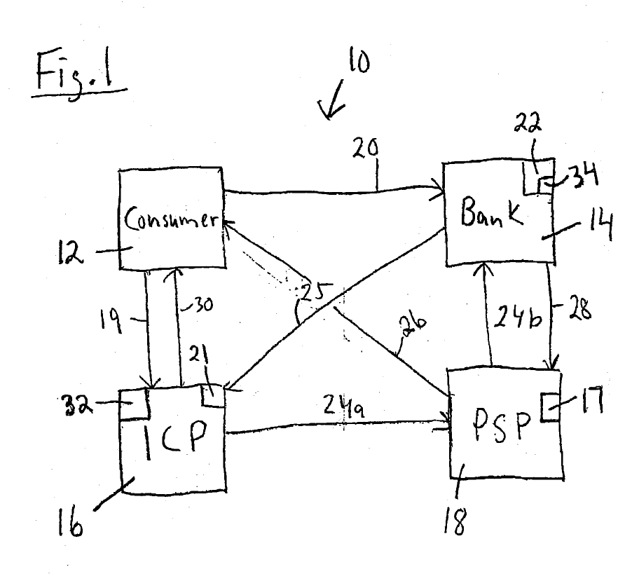

The present invention is a unique system for a pre-paid transaction system that enables consumers who, for example, do not have credit cards to buy products/services on the Internet. This means that no party of the transaction will be exposed to any credit risk since all transactions are pre-paid. With reference to FIG. 1, the system 10 has a consumer 12 who is connectable to a financial institution unit 14, such as a bank. The consumer may pay into the unit 14 by Internet banking, credit card or simply depositing money at the unit 14. The consumer 12 may also be connectable to an Internet content provider (ICP) 16, such as a seller on the Internet, and a payment service provider (PCP) 18. The seller 16 may be a seller of products and/or services.

In operation, the consumer 12 provides the unit 14 with a pre-paid fund 20. The fund 20 may go into an account 22 owned by the provider 16 but the fund 20 is ear marked for the consumer 12. The unit 14 may pay the provider 16 an interest for having access to the fund 20 in the account 22. The consumer 12 may go into a web site 17 of the provider 18 to obtain information about the funds that are available to the consumer 12. The consumer 12 may also obtain a list of transactions already completed so the consumer can see what the funds have been used for.

Before the consumer 12 may purchase 19 a product/service 32 using the fund 20 in the account 22, the consumer must activate a payment button 21 on the web site of the provider 16 that will ask the consumer to first identify him/herself with a user name and a password. Once the consumer 12 has approved the transaction, withdrawal signals 24a, 24b are transmitted from the provider 16 to the provider 18 and to the account 22 to withdraw the required funds to pay 25 for the product/service bought by the consumer 12. Upon receipt of the payment 25, the provider 16 sends the goods/services 30 to the consumer 12. The unit 14 also sends a confirmation signal 28 to the provider 18 to confirm that the payment 25 has been received. The provider 18 then sends a receipt signal 26 to the consumer 12 to confirm the purchase. The receipt may also have a transaction number that identifies the transaction and contact information to the provider 16. This may be useful if the consumer 12 receives no goods or services from the provider 16.

One important aspect of the present invention is that the provider 16 does not know any specifics of the consumer 12, such as name, address, fund size, account number, etc. Only the provider 18 may have additional information about the consumer 12 so the consumer may remain anonymous to the provider 16.

It is necessary for the provider 16 to register with the provider 18 before the consumer 12 can use the system 10 to purchase products/services from the provider 16. In this way, the provider 18 may screen the providers 16 so that only credible providers 16 are part of the system 10. It is also necessary for the provider 16 to install a program on the web site of the provider 16 so that the correct activation buttons appear on the web site and so that the consumer 12 may select the system 10 as the payment method. It is also necessary to properly connect the provider 18 and the provider 16 so that funds may be transferred from the account 22 of the provider 18 to the provider 16 after the purchase by the consumer has been completed.

One important feature of the present invention is that consumers who have no credit can buy on the Internet. Also, the consumers do not pay the provider 18 any fees so the service is inexpensive and convenient. However, there may be a small fee charged for deposits of very small amounts from the consumer or when the balance of the consumer's account is below a certain threshold level. The consumer will receive no interest on money deposited into the account of the provider 18. The provider 18 may guarantee to the seller 16 that all pre-paid funds 20 are available within, for example, 48 hours. In this way, the provider 18 will have access to the funds for 48 hours interest free. The provider 18 may also have funds interest free for a short time period before the fund is paid to the seller 16. The system 10 is particularly useful for small transactions so that it is not necessary to buy an entire class course when the consumer is only interested in certain sections of the course and only wants to pay for the time the consumer has access to the course material.

While the present invention has been described in accordance with preferred compositions and embodiments, it is to be understood that certain substitutions and alterations may be made thereto without departing from the spirit and scope of the following claims.

I claim:

1. A method of transacting business on the Internet, comprising:
providing a system 10 having a consumer 12 connected to a financial unit 14 and an Internet content provider 16 and a payment service provider 18;
the consumer 12 providing the financial unit 14 with a pre-paid fund 20;
the consumer 12 sending a purchase signal 19 to purchase a product/service 32 from the Internet content provider 16;
the Internet content provider 16 receiving the purchase signal 19 and sending a withdrawal signal 24a to the payment service provider 18;
the payment service provider 18 receiving the signal 24a and withdrawing a portion 34 of the fund 20 from the financial unit 14 and sending the portion 34 in a payment signal 25 to the Internet content provider 16; and
the Internet content provider 16 providing the product/service 32 to the consumer 12.

2. The method according to claim 1 wherein the method further comprises putting the fund 20 into an account 22 at the financial unit 14 and earmarking the fund 20 for the consumer 12.

3. The method according to claim 2 wherein the method further comprises the consumer 12 contacting a web site 17 of the payment service provider 18 to obtain information about available funds on the account 22.

4. The method according to claim 1 wherein the method further comprises the consumer 12 activating a payment button 21 of the Internet content provider 16.

5. The method according to claim 1 wherein the method further comprises the financial unit 14 sending a confirmation signal 28 to the payment service provider 18.

6. The method according to claim 1 wherein the method further comprises the provider 18 sending a receipt signal 26 to the consumer 12.
